(19) United States
(12) Patent Application Publication
(10) Pub. No.: US 2022/0043426 A1
(43) Pub. Date: Feb. 10, 2022

(54) NUMERICAL CONTROL DEVICE AND MACHINE LEARNING DEVICE

(71) Applicant: Mitsubishi Electric Corporation, Tokyo (JP)

(72) Inventors: Masakazu SAGASAKI, Tokyo (JP); Tsuyoshi KUMAZAWA, Tokyo (JP)

(73) Assignee: Mitsubishi Electric Corporation, Tokyo (JP)

(21) Appl. No.: 17/413,955

(22) PCT Filed: Dec. 28, 2018
(86) PCT No.: PCT/JP2018/048575

§ 371 Date: Jun. 15, 2021

(51) Int. Cl. G05B 19/4155; G05B 19/29

(52) U.S. Cl. CPC G05B 19/4155; G05B 19/295

(57) ABSTRACT

A numerical control device for controlling multiple drive shafts that drive a tool for machining an object to be machined includes an analysis processing unit that analyzes a machining program, a machining path calculation unit that calculates a machining path, which is a travel path of the tool in cutting machining of the object to be machined, based on a result of analysis of the machining program performed by the analysis processing unit, and an interrupt pathway calculation unit that calculates a travel path of the tool in an interrupt operation based on the result of analysis. The interrupt operation is an operation repeatedly performed in which the tool is temporarily lifted up from the machining path while the tool is moved along the machining path and is machining the object to be machined.

### FIELD

The present invention relates to a numerical control device for controlling a machining device that performs turning machining, and to a machine learning device.

### BACKGROUND

Conventional numerical control devices for controlling a machining device that performs turning machining have been proposed, one of which is a numerical control device that provides control to cause a cutting tool to vibrate at a low frequency along the machining path to machine a workpiece (e.g., Patent Literature 1).

The numerical control device described in Patent Literature 1 calculates the specified amount of movement per unit time based on a move command issued to a tool, calculates the amount of vibrational movement per unit time based on a vibration condition, combines the specified amount of movement and the amount of vibrational movement thus to calculate the amount of resultant movement, and thus controls vibration cutting based on the amount of resultant movement. The numerical control device described in Patent Literature 1 provides control to prevent the vibration frequency of a tool from exceeding a particular value to allow chips resulting from cutting of a workpiece to be broken into small pieces. This prevents chip entanglement with the tool, and can thus prevent occurrence of, for example, a problem in shortening of the tool life caused by chip entanglement.

### CITATION LIST

### Patent Literature

Patent Literature 1: Japanese Patent No. 5599523

### SUMMARY

### Technical Problem

A turning operation such as that described in Patent Literature 1 in which the cutting tool is vibrated at a low frequency along the machining path to machine a workpiece causes the frequency used when the cutting tool is vibrated at a low frequency to depend on the rotational speed of the spindle. This presents a problem in imposing a limitation on specifying the rotational speed of the spindle. For example, an increased rotational speed of the spindle for an increased machining speed will result in an increased vibration frequency of the cutting tool, which may hinder chips from being broken.

The present invention has been made in view of the foregoing, and it is an object of the present invention to provide a numerical control device capable of reliably breaking chips resulting from turning machining without being governed by the setting value of the rotational speed of the spindle.

### Solution to Problem

To solve the problem and achieve the object described above, the present invention is directed to a numerical control device for controlling multiple drive shafts that drive a tool for machining an object to be machined. The numerical control device includes an analysis processing unit that analyzes a machining program, and a machining path calculation unit that calculates a machining path based on a result of analysis of the machining program performed by the analysis processing unit, where the machining path is a travel path of the tool in cutting machining of the object to be machined. The numerical control device also includes an interrupt pathway calculation unit that calculates a travel path of the tool in an interrupt operation based on the result of analysis, where the interrupt operation is an operation repeatedly performed in which the tool is temporarily lifted up from the machining path while the tool is moved along the machining path and is machining the object to be machined.

### Advantageous Effects of Invention

A numerical control device according to the present invention is advantageous in being capable of reliably letting chips resulting from turning machining leave from an object to be machined without being governed by the setting value of the rotational speed of the spindle.

### BRIEF DESCRIPTION OF DRAWINGS

FIG. 1 is a diagram illustrating an example configuration of a numerical control device according to a first embodiment.

FIG. 2 is a diagram illustrating an example configuration of an interrupting machining command includable in a machining program to be executed by the numerical control device according to the first embodiment.

FIG. 3 is a diagram illustrating a first example of machining operation performed by a machining device under control of the numerical control device according to the first embodiment.

FIG. 4 is a diagram illustrating an example of machining program for implementing the machining operation illustrated in FIG. 3.

FIG. 5 is a diagram illustrating a second example of machining operation performed by a machining device under control of the numerical control device according to the first embodiment.

FIG. 6 is a diagram illustrating an example of machining program for implementing the machining operation illustrated in FIG. 5.

FIG. 7 is a diagram illustrating a third example of machining operation performed by a machining device under control of the numerical control device according to the first embodiment.

FIG. 8 is a flowchart illustrating an example of operation of the analysis processing unit included in the numerical control device according to the first embodiment.

FIG. 9 is a flowchart illustrating an example of operation of the interpolation processing unit included in the numerical control device according to the first embodiment.

FIG. 10 is a diagram illustrating a first example of interrupt operation performed by applying the numerical control device according to the first embodiment.

FIG. 11 is a diagram illustrating a second example of interrupt operation performed by applying the numerical control device according to the first embodiment.

FIG. 12 is a diagram illustrating a third example of interrupt operation performed by applying the numerical control device according to the first embodiment.

FIG. 13 is a diagram illustrating a fourth example of interrupt operation performed by applying the numerical control device according to the first embodiment.

FIG. 14 is a diagram illustrating an example hardware configuration of the control computing unit included in the numerical control device according to the first embodiment.

FIG. 15 is a diagram illustrating an example of boring machining.

FIG. 16 is a diagram for describing a possible problem in boring machining.

FIG. 17 is a diagram illustrating an example of machining operation causing an interference between the tool and the workpiece.

FIG. 18 is a diagram illustrating an example configuration of a numerical control device according to a second embodiment.

FIG. 19 is a flowchart illustrating an example of operation of the operating condition change unit included in the numerical control device according to the second embodiment.

### DESCRIPTION OF EMBODIMENTS

A numerical control device and a machine learning device according to embodiments of the present invention will be described in detail below with reference to the drawings. Note that these embodiments are not intended to limit the scope of this invention. In the description of the embodiments, the cutting tool included in a machining device is referred to as “tool”, and turning machining performed by a machining device is referred to as “machining”.

### First Embodiment

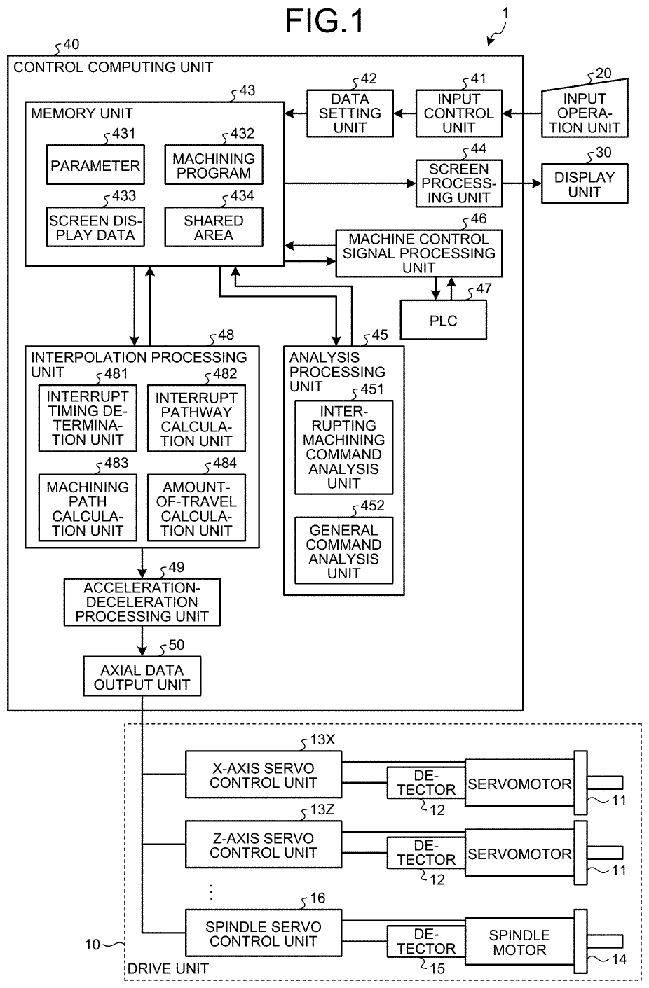

FIG. 1 is a diagram illustrating an example configuration of a numerical control device according to a first embodiment. A numerical control device 1 includes an input operation unit 20, a display unit 30, and a control computing unit 40. FIG. 1 also illustrates a drive unit 10 provided in a machining device controlled by the numerical control device 1. The other components of the machining device other than the drive unit 10 are omitted in the illustration.

The drive unit 10 provided in a machining device is a mechanism to drive one or both of the workpiece that is an object to be machined and the tool in at least two axial directions. In this example, the drive unit 10 includes multiple servomotors 11 that each move one or both of the workpiece and the tool in a corresponding axial direction defined on the numerical control device 1, and multiple detectors 12 that each detect the position and the speed of the rotor of the corresponding one of the servomotors 11. The drive unit 10 also includes an X-axis servo control unit 13X, a Z-axis servo control unit 13Z, . . . that respectively control the servomotors 11 based on the positions and on the speeds detected by the respective detectors 12. Note that when there is no need for distinction among directions of the drive shafts, the servo control unit for each axis (X-axis servo control unit 13X, Z-axis servo control unit 13Z, . . . ) is referred to simply as servo control unit 13. The drive unit 10 further includes a spindle motor 14 for rotating the spindle for rotating the workpiece, a detector 15 that detects the position and the rotational speed of the rotor of the spindle motor 14, and a spindle servo control unit 16 that controls the spindle motor 14 based on the position and on the rotational speed detected by the detector 15.

Returning to the description of the numerical control device 1, the input operation unit 20 is means for entering information in the numerical control device 1. The input operation unit 20 is configured by a keyboard, a button, a mouse, or the like. The input operation unit 20 receives an input such as a command, a machining program, or a parameter from a user to the numerical control device 1, and transfers the input to the control computing unit 40.

The display unit 30 is configured by a liquid crystal display device or the like to, for example, display information that has been processed by the control computing unit 40.

The control computing unit 40 includes an input control unit 41, a data setting unit 42, a memory unit 43, a screen processing unit 44, an analysis processing unit 45, a machine control signal processing unit 46, a programmable logic controller (PLC) 47, an interpolation processing unit 48, an acceleration-deceleration processing unit 49, and an axial data output unit 50. Note that the PLC 47 may be disposed outside the control computing unit 40.

The input control unit 41 receives information input from the input operation unit 20. The data setting unit 42 stores the information received by the input control unit 41 in the memory unit 43. For example, in a case in which the input information relates to edition of a machining program 432, the edition information is applied to the machining program 432 held by the memory unit 43, and in a case in which parameter information has been input, a parameter 431 held by the memory unit 43 is updated.

The memory unit 43 stores the parameter 431 for use in processing of the control computing unit 40, the machining program 432 to be executed, screen display data 433 to be displayed on the display unit 30, and the like. In this regard, the numerical control device 1 according to the present embodiment is capable of controlling a machining device according to an interrupting machining command newly defined, in addition to a command for general numerical control. Accordingly, the machining program 432 may include a description of an interrupting machining command. An interrupting machining command is a command to command an operation of temporarily stopping machining while the machining device is machining a workpiece, separating the tool from the workpiece, thereafter returning the tool into contact with the workpiece, and restarting machining. This sequence of operation may herein be referred to as “interrupt operation”. As used herein, the term “lift-up” refers to an operation of raising the tool apart from the machining path during machining while the tool is moved along the machining path. In addition, an operation of separation of the tool from the workpiece during interrupt operation may also be referred to as “lift-up of the tool”, or simply “lift-up”. Moreover, an operation of returning the tool to a state in contact with the workpiece from the state separated from the workpiece during interrupt operation may be referred to as “lift-down of the tool”, or simply “lift-down”. The interrupting machining command and the interrupt operation will be described in more detail later.

The memory unit 43 further includes a shared area 434 for storing data other than the parameter 431, the machining program 432, and the screen display data 433. This shared area 434 temporarily stores data generated during processing performed by the control computing unit 40 to control the drive unit 10. The screen processing unit 44 provides control to display the screen display data 433 held by the memory unit 43 on the display unit 30.

The analysis processing unit 45 includes an interrupting machining command analysis unit 451 and a general command analysis unit 452. The analysis processing unit 45 reads the machining program 432 including one or more blocks from the memory unit 43, and analyzes the machining program 432 read, by the interrupting machining command analysis unit 451 or by the general command analysis unit 452. The interrupting machining command analysis unit 451 analyzes an interrupting machining command included in the machining program 432, and writes the analysis result in the shared area 434 in the memory unit 43. The general command analysis unit 452 analyzes a command other than the interrupting machining command included in the machining program 432, and writes the analysis result in the shared area 434 in the memory unit 43. A command other than the interrupting machining command included in the machining program 432 may be referred to hereinafter as general command.

When the analysis processing unit 45 reads an auxiliary command that will function as a command for operating the machine, and is not a command for operating a drive shaft that is a numerically-controlled shaft, the machine control signal processing unit 46 notifies the PLC 47 that an auxiliary command has been issued. Examples of the auxiliary command include an M code and a T code.

Upon reception, from the machine control signal processing unit 46, of the notification that an auxiliary command has been issued, the PLC 47 performs processing corresponding to that auxiliary command. The PLC 47 holds a ladder program including a description of machine operation. Upon reception of a T code or an M code that is an auxiliary command, the PLC 47 performs processing corresponding to the auxiliary command according to the ladder program. After performing processing corresponding to the auxiliary command, the PLC 47 transmits, to the machine control signal processing unit 46, a completion signal indicating completion of processing corresponding to the auxiliary command to allow execution of the next block of the machining program 432.

In the control computing unit 40, the analysis processing unit 45, the machine control signal processing unit 46, and the interpolation processing unit 48 are connected to one another via the memory unit 43. The analysis processing unit 45, the machine control signal processing unit 46, and the interpolation processing unit 48 provide and receive various items of information to and from one another via the shared area 434 in the memory unit 43. In describing transmission and reception of information to and from the analysis processing unit 45, the machine control signal processing unit 46, and the interpolation processing unit 48, description will hereinafter be omitted stating that such transmission and reception are performed via the memory unit 43.

When the analysis processing unit 45 has analyzed a command including an argument relating to the travel path of the tool, the interpolation processing unit 48 calculates the travel path of the tool through interpolation operation using the argument included in the command analyzed. The command including an argument relating to the travel path of the tool is a command including at least one of: an argument specifying the position of the tool, an argument specifying the travel speed of the tool, an argument specifying the interpolation method for use in interpolation operation, and the like. The interrupting machining command described later is also a type of command including an argument relating to the travel path of the tool.

The interpolation processing unit 48 includes an interrupt timing determination unit 481, an interrupt pathway calculation unit 482, a machining path calculation unit 483, and an amount-of-travel calculation unit 484.

The interrupt timing determination unit 481 determines the timing of performing of interrupt operation based on the analysis result obtained by analysis of the interrupting machining command included in the machining program 432, which is performed by the interrupting machining command analysis unit 451 of the analysis processing unit 45.

The interrupt pathway calculation unit 482 calculates the travel path of the tool during the interrupt operation based on the analysis result obtained by analysis of the interrupting machining command performed by the interrupting machining command analysis unit 451 of the analysis processing unit 45.

The machining path calculation unit 483 calculates the travel path of the tool when interrupt operation is not performed, based on the analysis result obtained by analysis of a general command included in the machining program 432, which is performed by the general command analysis unit 452 of the analysis processing unit 45. The travel path of the tool calculated by the machining path calculation unit 483 is the travel path of the tool upon machining of the workpiece, that is, the travel path of the tool when the tool actually cuts the workpiece, which represents the machining path.

The amount-of-travel calculation unit 484 calculates, for each of the drive shafts, the amount of travel representing the distance of travel of the tool per unit time of a predetermined length, based on the travel path of the tool calculated by the interrupt pathway calculation unit 482, on the travel path of the tool calculated by the machining path calculation unit 483, and on the travel speed of the tool specifying by the corresponding argument. That is, the amount-of-travel calculation unit 484 calculates the distance to move the tool per unit time for each of the drive shafts. For example, in a case in which the drive shafts are two drive shafts along X-axis and Z-axis, the amount-of-travel calculation unit 484 calculates the amount of X-axis travel representing the distance of travel of the tool along the X-axis per unit time and the amount of Z-axis travel representing the distance of travel of the tool along the Z-axis per unit time. The amount-of-travel calculation unit 484 outputs the calculated amount of travel for each of the drive shafts to the acceleration-deceleration processing unit 49.

The acceleration-deceleration processing unit 49 converts the amount of travel for each of the drive shafts received from the amount-of-travel calculation unit 484 of the interpolation processing unit 48, into a move command per unit time taking into consideration acceleration and deceleration, based on a predesignated acceleration-deceleration pattern.

The axial data output unit 50 outputs the move command per unit time output from the acceleration-deceleration processing unit 49 to the servo control units 13 that control the respective drive shafts (the X-axis servo control unit 13X, the Z-axis servo control unit 13Z, . . . ). Note that upon reception of the move command from the acceleration-deceleration processing unit 49, each of the servo control units 13 controls the corresponding servomotor 11 according to the move command received.

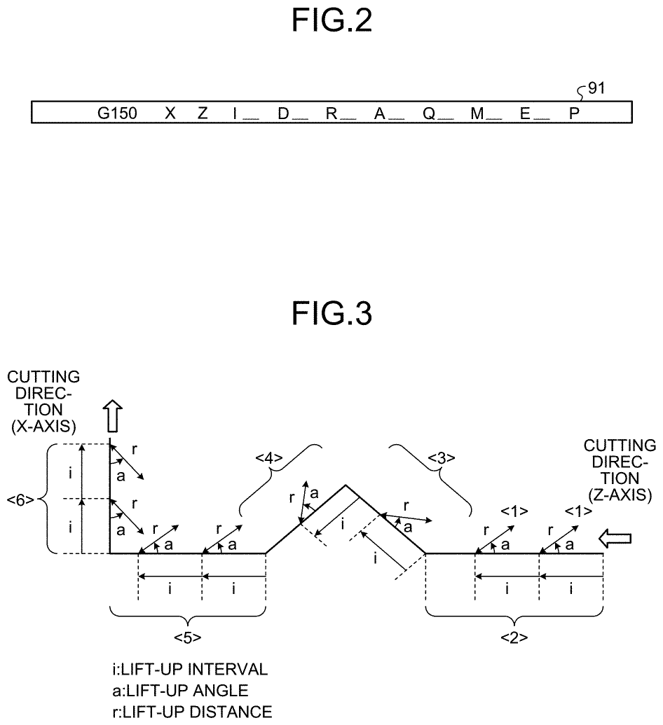

The interrupting machining command will next be described. FIG. 2 is a diagram illustrating an example configuration of an interrupting machining command includable in a machining program to be executed by the numerical control device 1 according to the first embodiment.

As illustrated in FIG. 2, the present embodiment assumes that a G150 code 91 represents the interrupting machining command. In addition, the G150 code 91 has a structure that allows X, Z, I, D, R, A, Q, M, E, and P parameters to be contained as addresses each representing an argument. Those having an underscore ‘_’ on the right side of the addresses of the G150 code 91 illustrated in FIG. 2 will have a numerical value placed at the position indicated by the underscore.

Once the interrupting machining command is executed to set operational conditions for the interrupt operation, the numerical control device 1 controls the drive unit 10 to repeat the interrupt operation under a same set of operational conditions until the interrupting machining command is newly executed to change an operational condition for the interrupt operation or until a command for canceling the setting is executed. An example of the command for canceling the setting may be a G150 code having all the arguments being omitted (single-element command of G150). The addresses includable in the interrupting machining command (G150 code) will each be described below.

The addresses X and Z are used to specify the axes of operation in interrupt operation. The character X represents the X-axis, and the character Z represents the Z-axis. For example, in a case in which a G150 code includes the address X and does not include the address Z, the numerical control device 1 controls the drive unit 10 to perform interrupt operation only in the X-axis direction. That is, the numerical control device 1 controls the drive unit 10 to cause the tool to move only in the X-axis direction to leave the workpiece. Alternatively, in a case in which a G150 code includes X and Z, the numerical control device 1 controls the drive unit 10 to perform interrupt operation in the X-axis and Z-axis directions. The distance of travel of the tool in interrupt operation is specified by the address R described later. Unless used as a command for canceling the setting, a G150 code needs to include at least one of X and Z. Note that when a G150 code includes only one of X and Z, a case may occur in which operation according to a command value specified using an address described later is unable to be performed. This makes it desirable that a G150 code include both X and Z.

The address I is used to specify the timing of repetition of interrupt operation. Specifically, the address I is used to specify the amount of travel of the tool during a time period after an iteration of the interrupt operation and before a next iteration of the interrupt operation. The numerical value suffixed to the character I represents the amount of travel of the tool. The amount of travel of the tool can be specified using the distance or the time period of travel of the tool. For example, in a case of specification of the amount of travel using the distance, the numerical control device 1 controls the drive unit 10 to perform an interrupt operation each time the tool moves the specified distance. Whether the address I specifies a distance or a time period as the amount of travel of the tool is specified by the address D.

The address D is used to specify the movement mode, i.e., whether the amount of travel specified by the address I is given by a distance or by a time period. The present embodiment assumes, by way of example, that D0 specifies use of a distance, and D1 specifies use of a time period.

The address R is used to specify the amount of lift-up of the tool, i.e., how much to move the tool when the tool is separated from the workpiece. The numerical value suffixed to the character R represents the lift-up distance of the tool. The lift-up operation is performed to move the tool by the distance equivalent to the lift-up distance specified. This means that the lift-up distance is the amount of travel of the tool when the tool is separated from the workpiece. A value greater than the cut depth of the tool during machining is usually specified as the lift-up distance. This allows the tool to be separated from the workpiece in the lift-up operation, thereby enabling chips to be broken when the tool is separated from the workpiece.

The address A is used to specify the lift-up angle of the tool, i.e., the angle at which the tool is lifted up. The numerical value suffixed to the character A represents the lift-up angle of the tool. The angle is an angle with respect to the direction of travel of the tool during machining. For example, when the tool is moving in parallel with the X-axis for machining, the angle to be specified by the address A is an angle with respect to the X-axis.

The address Q is used to specify the post-lift-up dwell time, i.e., the length of time of maintaining the tool in an unmoved state after the tool is lifted up by the lift-up distance specified by the address R described above. The numerical value suffixed to the character Q represents the post-lift-up dwell time. The dwell time is specified by the number of revolutions of the spindle. For example, the dwell time of “Q1” is a time required for one revolution of the spindle. The numerical control device 1 controls the drive unit 10 to start to lift down the tool after a lapse of the time specified as the post-lift-up dwell time (after the specified number of revolutions of the spindle) after completion of lifting up the tool.

The address M is used to specify the lift-down return position, i.e., the position to which the tool is to be returned by a lift-down operation. The numerical value suffixed to the character M represents the lift-down return position. The lift-down return position represents the distance (backward distance) from the position of the tool at the start of lift-up, to the position after returning of the tool by lift-down. In a case of omission of the address M, the numerical control device 1 controls the drive unit 10 to return the tool to the position coincident with the position at the start of the lift-up.

The address E is used to specify the lift-up speed of the tool, i.e., the travel speed of the tool during lift-up. The numerical value suffixed to the character E represents the lift-up speed of the tool. Note that the travel speed of the tool during lift-down is assumed to be the same as the travel speed of the tool during lift-up.

The address P is used to specify whether the tool is lifted down along a path having a linear shape or having an arcuate shape. When the interrupting machining command includes the address P, the numerical control device 1 controls the drive unit 10 to lift down the tool along a path having an arcuate shape. Alternatively, when the interrupting machining command does not include the address P, the numerical control device 1 controls the drive unit 10 to lift down the tool along a path having a linear shape.

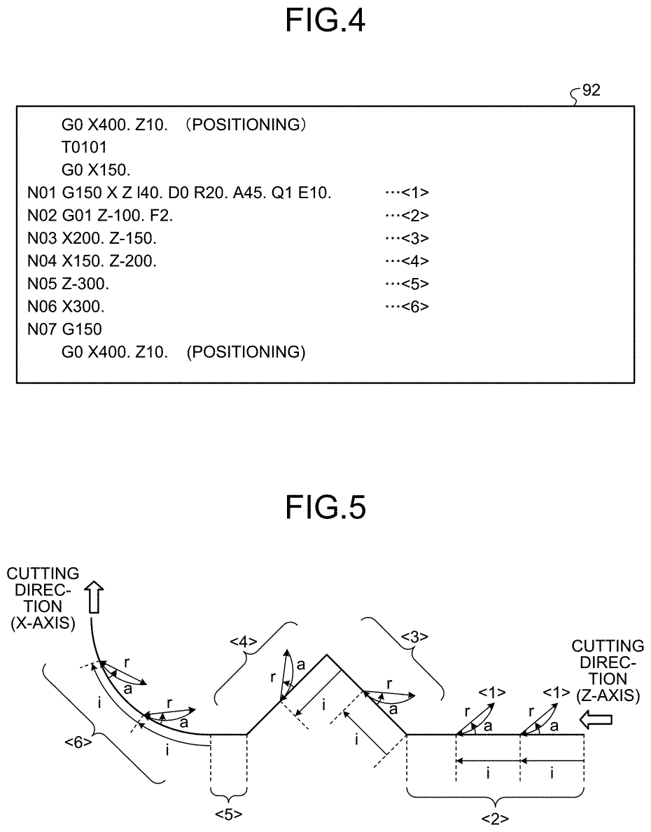

A specific example of machining operation provided by the numerical control device 1 according to the present embodiment will next be described with reference to FIGS. 3 and 4. FIG. 3 is a diagram illustrating a first example of machining operation performed by a machining device under control of the numerical control device 1 according to the first embodiment. FIG. 4 is a diagram illustrating an example of machining program for implementing the machining operation illustrated in FIG. 3.

In FIG. 3, “i” represents the lift-up interval, “a” represents the lift-up angle, and “r” represents the lift-up distance. In addition, the sections <1> through <6> illustrated in FIG. 3 correspond respectively to the commands <1> through <6> illustrated in FIG. 4. As illustrated in FIG. 3, the lift-up angle refers to the angle between the machining path along which the tool has moved and the travel path of the tool during lift-up. The present embodiment assumes that the lift-up angle is greater than 0° and less than or equal to 90°.

In the machining program 92 illustrated in FIG. 4, “G0” represents a positioning command, and “X400”, “Z10”, etc. following “G0” represent the positions of the corresponding drive shafts. The address X corresponds to the X-axis, and the address Z corresponds to the Z-axis. “T0101” represents a tool command. The first two digits following the character T together represent the tool number, and the remaining two digits together represent the offset value for correcting the position of the tool.

“G150” at the sequence number N01 is the interrupting machining command described above. In the example illustrated in FIG. 4, the addresses “X”, “Z”, “I40.”, “D0”, “R20.”, “A45.”, “Q1”, and “E10.” are included as the arguments. This interrupting machining command specifies the X-axis and the Z-axis as the symmetric axes of the interrupt operation, and specifies that an interrupt operation be performed each time the tool moves 40 mm. That is, the interval of performing the interrupt operation is specified to be 40 mm. In addition, the lift-up distance of the tool is specified to be 20 mm, the lift-up angle of the tool is specified to be 45°, and the lift-up speed of the tool is specified to be 10 mm/rev. Moreover, the post-lift-up dwell time is specified to be a time equivalent to one revolution of the spindle, and the path for returning to the lift-up start position during lift-down is specified to be a linear path. After execution of the interrupting machining command, the numerical control device 1 configures the operation to perform interrupt operation according to the conditions specified by the arguments included in the command, and then starts controlling of the drive unit 10.

The commands associated with the sequence numbers N02 through N06 are linear interpolation commands. In “G01 Z-100. F2.” at the sequence number N02, “Z-100.” is a command value specifying the Z-axis coordinate of the tool, and “F2.” is a command value specifying the tool feed rate per one revolution of the spindle. Specifically, “G01 Z-100. F2.” is a linear interpolation command representing an instruction to move the tool at a feed rate of 2 mm/rev until the Z-axis coordinate reaches −100. Note that because no change is made in the X-axis coordinate of the tool, the command at the sequence number N02 has the command value omitted that specifies the X-axis coordinate of the tool. Execution of the command at the sequence number N02 by the numerical control device 1 causes the tool to move over the section <2> illustrated in FIG. 3. In this operation, the numerical control device 1 executes the interrupting machining command before the execution of the command at the sequence number N02. Thus, when the operational conditions for the interrupt operation are satisfied during traveling of the tool in the section <2> illustrated in FIG. 3, that is, when the amount of travel of the tool reaches the amount of travel specified as the interrupt interval, the numerical control device 1 performs the interrupt operation to lift up the tool. In the example illustrated in FIGS. 3 and 4, the numerical control device 1 lifts up the tool at a lift-up angle of 45° each time the tool is moved 40 mm. The lift-up angle is an angle with respect to the direction opposite the direction of travel of the tool. In this operation, the lift-up speed of the tool is 10 mm/rev, and the lift-up distance is 20 mm. In addition, after lifting up the tool by 20 mm, the numerical control device 1 stops the tool until the spindle rotates one complete revolution, and then returns the tool to the original position, i.e., the position at the start of the lift-up. In this operation, the numerical control device 1 controls the drive unit 10 to allow the tool to return to the original position along a linear path that minimizes the travel distance. Because the tool moves 110 mm in the section <2>, the interrupt operation is performed twice in this section.

In addition, “X200. Z-150.” at the sequence number N03 is a linear interpolation command representing an instruction to move the tool at a feed rate of 2 mm/rev until the X-axis coordinate reaches 200, and the Z-axis coordinate reaches −150. Note that “X200. Z-150.” is a linear interpolation command similarly to the command at the sequence number N02 immediately therebefore. The parameter “G01” indicating a linear interpolation command is therefore omitted. In addition, because no change is made in the feed rate, the command value “F2.” for the feed rate is also omitted. Execution of the command at the sequence number N03 by the numerical control device 1 causes the tool to move over the section <3> illustrated in FIG. 3. In this operation, similarly to when the tool moves over the section <2>, the numerical control device 1 lifts up the tool when the operational conditions for the interrupt operation are satisfied. The numerical control device 1 lifts up the tool in a manner similar to the manner in the section <2> described above. The interrupt operation is performed once in the section <3>.

“X150. Z-200.” at the sequence number N04 is a linear interpolation command representing an instruction to move the tool at a feed rate of 2 mm/rev until the X-axis coordinate reaches 150, and the Z-axis coordinate reaches −200. Similarly to the command at the sequence number N03, “G01” and “F2.” are omitted. Execution of the command at the sequence number N04 by the numerical control device 1 causes the tool to move over the section <4> illustrated in FIG. 3. In this operation, similarly to when the tool moves over the sections <2> and <3>, the numerical control device 1 lifts up the tool when the operational conditions for the interrupt operation are satisfied. The numerical control device 1 lifts up the tool in a manner similar to the manner in the sections <2> and <3> described above. The interrupt operation is performed once in the section <4>.

“Z-300.” at the sequence number N05 is a linear interpolation command representing an instruction to move the tool at a feed rate of 2 mm/rev until the Z-axis coordinate reaches −300. Similarly to the command at the sequence number N03, “G01” and “F2.” are omitted. Execution of the command at the sequence number N05 by the numerical control device 1 causes the tool to move over the section <5> illustrated in FIG. 3. In this operation, similarly to when the tool moves over the sections <2> through <4>, the numerical control device 1 lifts up the tool when the operational conditions for the interrupt operation are satisfied. The numerical control device 1 lifts up the tool in a manner similar to the manner in the sections <2> through <4> described above. The interrupt operation is performed twice in the section <5>.

“X300.” at the sequence number N06 is a linear interpolation command representing an instruction to move the tool at a feed rate of 2 mm/rev until the X-axis coordinate reaches 300. Similarly to the command at the sequence number N03, “G01” and “F2.” are omitted. Execution of the command at the sequence number N06 by the numerical control device 1 causes the tool to move over the section <6> illustrated in FIG. 3. In this operation, similarly to when the tool moves over the sections <2> through <5>, the numerical control device 1 lifts up the tool when the operational conditions for the interrupt operation are satisfied. The numerical control device 1 lifts up the tool in a manner similar to the manner in the sections <2> through <5> described above. The interrupt operation is performed twice in the section <6>.

All the arguments being omitted, “G150” at the sequence number N07 is a cancel command for terminating the interrupted machining, that is, for cancelling the interrupt operation. The numerical control device 1 executes the cancel command at the sequence number N07, and cancels the setting of the operational conditions for the interrupt operation.

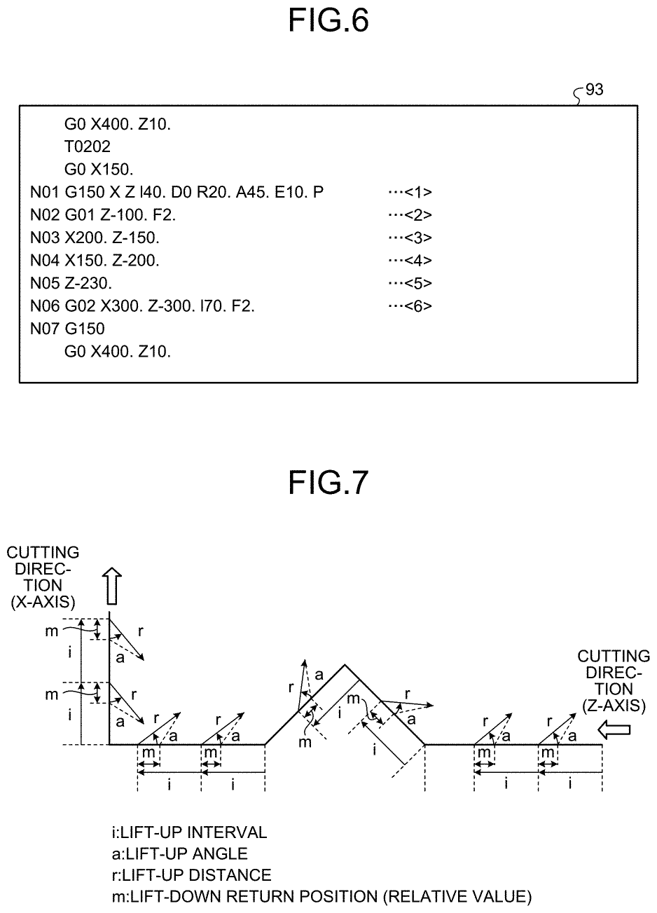

A second example of machining operation provided by the numerical control device 1 according to the present embodiment will next be described with reference to FIGS. 5 and 6. FIG. 5 is a diagram illustrating a second example of machining operation performed by a machining device under control of the numerical control device 1 according to the first embodiment. FIG. 6 is a diagram illustrating an example of machining program for implementing the machining operation illustrated in FIG. 5.

In FIG. 5, “i” represents the lift-up interval, which is the interval of performing interrupt operation, “a” represents the lift-up angle, and “r” represents the lift-up distance. In addition, the sections <1> through <6> illustrated in FIG. 5 correspond respectively to the commands <1> through <6> illustrated in FIG. 6.

The commands prior to the command at the sequence number N01 in the machining program 93 illustrated in FIG. 6 are similar to the corresponding commands in the machining program 92 illustrated in FIG. 4, and description thereof will therefore be omitted.

“G150” at the sequence number N01 is the interrupting machining command described above. In the example illustrated in FIG. 6, the addresses “X”, “Z”, “I40.”, “D0”, “R20.”, “A45.”, “E10.”, and “P” are included as the arguments. This interrupting machining command specifies the X-axis and the Z-axis as the symmetric axes of the interrupt operation, and specifies that an interrupt operation be performed each time the tool moves 40 mm. That is, the interval of performing the interrupt operation is specified to be 40 mm. In addition, the lift-up distance of the tool is specified to be 20 mm, the lift-up angle of the tool is specified to be 45°, and the lift-up speed of the tool is specified to be 10 mm/rev. These conditions are similar to those for the interrupt operation in the first example illustrated in FIG. 3. Meanwhile, the post-lift-up dwell time is unspecified. In addition, the path for returning to the position at the start of lift-up during lift-down is specified to have an arcuate shape. After execution of the interrupting machining command, the numerical control device 1 configures the operation to perform interrupt operation according to the conditions specified by the arguments included in the command, and then starts controlling of the drive unit 10.

The commands at the sequence numbers N02 through N04 illustrated in FIG. 6 are identical to the commands at the respective same sequence numbers illustrated in FIG. 4. Therefore, the path followed by the tool during machining of the workpiece over the sections <2> through <4> illustrated in FIG. 5 is identical to the path followed by the tool during machining of the workpiece over the sections <2> through <4> illustrated in FIG. 3. However, due to a difference in some of the conditions for the interrupt operation, the path followed by the tool during interrupt operation, specifically, the path followed by the tool during lift-down, differs from the path in the first example illustrated in FIG. 3.

In the example illustrated in FIGS. 5 and 6, the numerical control device 1 lifts up the tool at a lift-up angle of 45° with a lift-up speed of 10 mm/rev by a lift-up distance of 20 mm, each time the tool is moved 40 mm. The operation up to this point is similar to the operation illustrated in FIGS. 3 and 4. After lifting up the tool by a lift-up distance of 20 mm, the numerical control device 1 immediately returns the tool to the original position, i.e., the position at the start of the lift-up. The numerical control device 1 controls the drive unit 10 to cause the tool to follow an arcuate path in this operation. The numerical control device 1 calculates the path to be followed by the tool through arc interpolation using the set of coordinates of the tool at the start of lift-down and the set of coordinates of the original position of the tool (the set of coordinates of the tool at the end of the lift-down). Use of an arcuate shape for the path of the lifted-up tool in returning to the original position allows the workpiece to be less likely to suffer from a tool mark when the tool comes into contact with the workpiece again, which enables machining accuracy to be improved.

“Z-230.” at the sequence number N05 illustrated in FIG. 6 is a linear interpolation command representing an instruction to move the tool at a feed rate of 2 mm/rev until the Z-axis coordinate reaches −230. Execution of the command at the sequence number N05 illustrated in FIG. 6 by the numerical control device 1 causes the tool to move over the section <5> illustrated in FIG. 5. In this operation, the distance of travel of the tool in the section <5> of FIG. 5 is 30 mm, and is shorter than the interval of 40 mm of performing the interrupt operation specified by the interrupting machining command. No lift-up is thus performed in the section <5> of FIG. 5.

“G02 X300. Z-300. 170. F2.” at the sequence number N06 illustrated in FIG. 6 is a command of clockwise arc interpolation representing an instruction to move the tool at a feed rate of 2 mm/rev until the X-axis coordinate reaches 300 and the Z-axis coordinate reaches −300. Execution of the command at the sequence number N06 illustrated in FIG. 6 by the numerical control device 1 causes the tool to move over the section <6> illustrated in FIG. 5. Also in this case, the numerical control device 1 performs the interrupt operation each time the tool moves 40 mm, which is the value set as the interval of performing interrupt operation. The lift-up angle in this operation is the angle with respect to the tangent to the arc at the position of the tool at the time of start of lift-up. The lift-up operation is performed twice in the section <6> illustrated in FIG. 5.

“G150” at the sequence number N07 illustrated in FIG. 6 is a command (cancel command) similar to “G150” at the sequence number N07 illustrated in FIG. 4.

A third example of machining operation provided by the numerical control device 1 according to the present embodiment will next be described with reference to FIG. 7. FIG. 7 is a diagram illustrating a third example of machining operation performed by a machining device under control of the numerical control device 1 according to the first embodiment.

The third example illustrated in FIG. 7 differs from the first example illustrated in FIG. 3 in the return position of the tool after lift-up. That is, in the example illustrated in FIG. 7, the numerical control device 1 returns the tool to a position a distance m back from the position at the start of lift-up, which distance m is specified by the lift-down return position (address M) in the interrupting machining command. For example, in the case of m=5 as illustrated in FIG. 7 (lift-up return position is 5 mm), machining in the third example can be performed by replacement of “G150 X Z 140. D0 R20. A45. Q1 E10.” at the sequence number N01 in the machining program for performing machining of the first example (the machining program 92 illustrated in FIG. 4) with “G150 X Z 140. D0 R20. A45. Q1 M5 E10.”. When machining is restarted after returning the lifted-up tool to a position back from the original position (position at the start of lift-up) as in the situation illustrated in FIG. 7, remaining chips can be cut off upon restart of machining even when uncut chips are left on the workpiece after lift-up.

Of the components of the numerical control device 1 according to the present embodiment, components for implementing operation to control a machining device according to the interrupting machining commands described above, specifically, the analysis processing unit 45 and the interpolation processing unit 48, will next be described in detail.

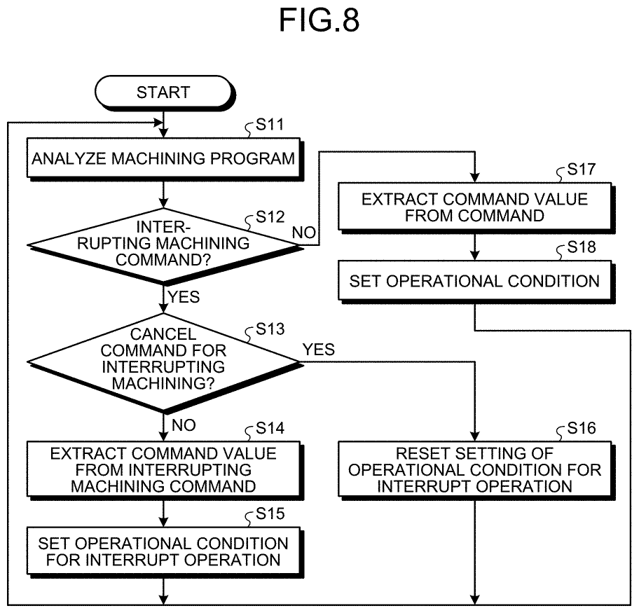

FIG. 8 is a flowchart illustrating an example of operation of the analysis processing unit 45 included in the numerical control device 1 according to the first embodiment. For example, upon reception, via the input operation unit 20, of operation from the user giving an instruction to start controlling of the machining device according to the machining program 432, the analysis processing unit 45 starts the operation illustrated in FIG. 8.

At the beginning of the operation, the analysis processing unit 45 first reads the machining program 432 from the memory unit 43, and analyzes the machining program 432 (step S11). Specifically, the analysis processing unit 45 analyzes the machining program 432, and reads one block constituting one command.

Next, the analysis processing unit 45 checks whether the command that has been read is an interrupting machining command (step S12), and if the command is an interrupting machining command, i.e., a G150 code (step S12: Yes), checks whether the command is a type of cancel command for interrupted machining (step S13). The operation of this step S13 and of after-mentioned steps S14 to S16 is performed by the interrupting machining command analysis unit 451. When the G150 code is a single-element command not including any arguments such as the address X, the interrupting machining command analysis unit 451 determines that the command is a type of cancel command.

If the command is not a type of cancel command (step S13: No), the interrupting machining command analysis unit 451 extracts the command value(s) from the interrupting machining command (step S14). The term “command value” as used herein refers to information provided by an argument included in an interrupting machining command, examples of which include information representing the axes of operation in the interrupt operation specified by the addresses X and Z, and information on the timing of repetition of the interrupt operation specified by the address I.

Next, the interrupting machining command analysis unit 451 sets the operational conditions for the interrupt operation based on the command value(s) extracted at step S14 (step S15). Specifically, the interrupting machining command analysis unit 451 writes the command value(s) extracted, in the shared area 434 in the memory unit 43 to set the operational conditions for the interrupt operation. In this operation, the interrupting machining command analysis unit 451 writes each command value in a predetermined area in the shared area 434. Note that when the interrupting machining command analysis unit 451 performs step S15 under a condition in which the operational conditions for the interrupt operation have already been set, the operational conditions for the interrupt operation are updated.

Otherwise, if the command that has been read is a type of cancel command for interrupted machining (step S13: Yes), the interrupting machining command analysis unit 451 resets the setting of the operational conditions for the interrupt operation (step S16). Specifically, the interrupting machining command analysis unit 451 clears the operational conditions for the interrupt operation written in the shared area 434 in the memory unit 43. Note that the setting of the operational conditions for the interrupt operation may also be reset such that the shared area 434 is provided with a flag indicating that the setting of the operational conditions for the interrupt operation is valid, and the interrupting machining command analysis unit 451 clears this flag. In this case, at step S15 described above, the interrupting machining command analysis unit 451 writes the command value(s) extracted from the interrupting machining command in the shared area 434, and sets the flag indicating that the setting of the operational conditions for the interrupt operation is valid.

Alternatively, if the command that has been read after analysis of the machining program 432 is not an interrupting machining command (step S12: No), the analysis processing unit 45 extracts the command value(s) from the command that has been read (step S17), and sets operational condition(s) for the operation to machine a workpiece, according to the command value(s) extracted (step S18). The operation of these steps S17 and S18 is performed by the general command analysis unit 452. For example, in a case in which the command that has been read is a G01 code, which is a linear interpolation command, the general command analysis unit 452 extracts, at step S17, the command value(s) each representing the coordinate of the tool and the command value specifying the feed rate of the tool. In addition, the general command analysis unit 452 writes, at step S18, the command value(s) extracted, in a predetermined area in the shared area 434 to set the operational condition(s). In this operation, the general command analysis unit 452 also writes information representing the command that has been read, i.e., information representing the linear interpolation command, in the shared area 434. Also in a case in which the command that has been read is not a linear interpolation command presented by a G01 code, the general command analysis unit 452 similarly extracts the command value(s) from the command that has been read, and writes the command value(s) extracted and information representing the type of the command that has been read, in a predetermined area in the shared area 434 to set the operational condition(s). Note that the operational condition(s) for the operation to machine a workpiece is or are updated each time the general command analysis unit 452 performs step S18. The following description may describe “information representing the type of the command” as “the type of the command”.

After performing steps S15, S16, and S18, the analysis processing unit 45 returns the process to step S11 to read a next command, and thus continues the operation.

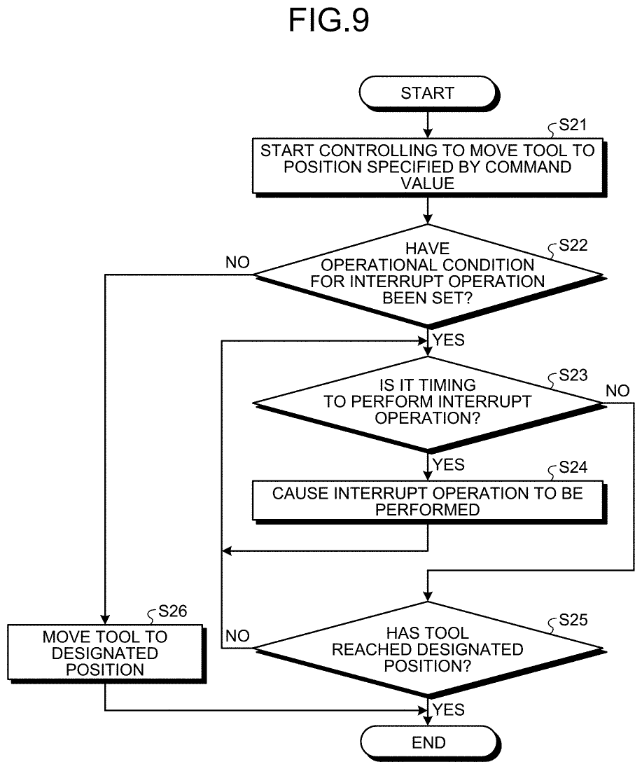

FIG. 9 is a flowchart illustrating an example of operation of the interpolation processing unit 48 included in the numerical control device 1 according to the first embodiment. The flowchart of FIG. 9 illustrates an operation of the interpolation processing unit 48 in which the numerical control device 1 controls the drive unit 10 of a machining device to machine a workpiece.

For example, the interpolation processing unit 48 periodically checks information written in the shared area 434 in the memory unit 43, and upon detection of updating of a command value specifying a coordinate of the tool, starts the operation illustrated in FIG. 9.

At the beginning of the operation, the interpolation processing unit 48 starts controlling of moving the tool to the position specified by the corresponding command value(s) written in the shared area 434 (step S21). At step S21, the interpolation processing unit 48 generates control information on the drive unit 10 based on information such as the type of the command, a command value specifying the coordinate of the corresponding one of the drive shafts of the tool, and a command value specifying the feed rate of the tool, among the information written in the shared area 434. Specifically, first, the machining path calculation unit 483 calculates the travel path of the tool up to the designated position, which is the position specified by the corresponding command value(s), based on the type of the command, on the command value(s) each specifying the coordinate of the corresponding one of the drive shafts of the tool, and on the current position of the tool. Next, the amount-of-travel calculation unit 484 calculates, for each of the drive shafts, the amount of travel of the tool per unit time based on the travel path calculated by the machining path calculation unit 483 and on the feed rate of the tool. The amount-of-travel calculation unit 484 outputs the amount of travel of the tool per unit time calculated for each of the drive shafts to the acceleration-deceleration processing unit 49.

Next, the interpolation processing unit 48 checks whether the operational conditions for the interrupt operation have been set (step S22), and if the operational conditions have not been set (step S22: No), moves the tool to the designated position (step S26), and terminates the operation.

Meanwhile, if the operational conditions for the interrupt operation have been set (step S22: Yes), the interpolation processing unit 48 checks whether it is the timing to perform the interrupt operation (step S23). The check on whether it is the timing to perform the interrupt operation is performed by the interrupt timing determination unit 481. At step S23, the interrupt timing determination unit 481 checks whether the amount of travel of the tool from the start of the travel of the tool, or the amount of travel of the tool from the last interrupt operation, has reached the amount of travel, which is specified as the interrupt interval that has been set as an operational condition for the interrupt operation written in the shared area 434. If the amount of travel of the tool has reached the amount of travel specified as the interrupt interval, the interrupt timing determination unit 481 determines that it is the timing to perform the interrupt operation.

If it is the timing to perform the interrupt operation (step S23: Yes), the interpolation processing unit 48 causes the interrupt operation to be performed (step S24). That is, the interpolation processing unit 48 generates control information for causing the machining device to perform the interrupt operation. Specifically, first, the interrupt pathway calculation unit 482 calculates the path of the tool during the interrupt operation, based on each command value included in the operational conditions for the interrupt operation. For example, when the analysis processing unit 45 has read the interrupt command at the sequence number N01 of the machining program 92 illustrated in FIG. 4, and has set the operational conditions for the interrupt operation, the interrupt pathway calculation unit 482 calculates the path of the tool to result in the interrupt operation illustrated in FIG. 3. Next, the amount-of-travel calculation unit 484 calculates, for each of the drive shafts, the amount of travel of the tool per unit time based on the path of the tool calculated by the interrupt pathway calculation unit 482, and on the lift-up speed specified by the operational conditions for the interrupt operation. The amount-of-travel calculation unit 484 outputs the amount of travel of the tool per unit time calculated for each of the drive shafts to the acceleration-deceleration processing unit 49. At step S24, the amount-of-travel calculation unit 484 repeats operation of calculation of the amount of travel of the tool per unit time and of outputting the amount of travel of the tool per unit time to the acceleration-deceleration processing unit 49 until the interrupt operation is completed, that is, until the tool returns to the position indicated by the operational conditions for the interrupt operation.

Upon termination of the interrupt operation at step S24, the interpolation processing unit 48 returns the process to step S23. Alternatively, if it is not the timing to perform the interrupt operation (step S23: No), the interpolation processing unit 48 checks whether the tool has reached the designated position (step S25). If the tool has not yet reached the designated position (step S25: No), the interpolation processing unit 48 returns the process to step S23. If the tool has reached the designated position (step S25: Yes), the interpolation processing unit 48 terminates the operation.

Some variations of the interrupt operation provided by the numerical control device 1 according to the present embodiment will next be described.

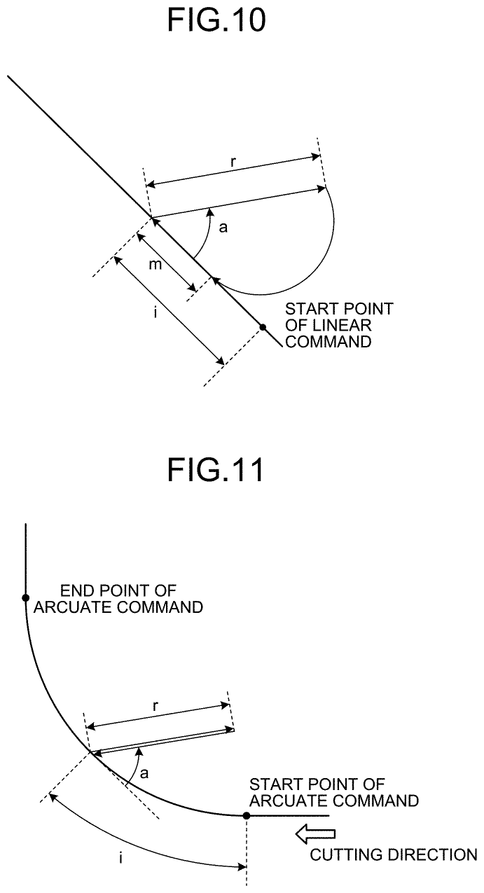

FIG. 10 is a diagram illustrating a first example of interrupt operation performed by applying the numerical control device 1 according to the first embodiment.

The interrupt operation illustrated in FIG. 10 corresponds to a case in which the interrupting machining command includes an argument specifying a backward distance (m) after lift-down and an argument specifying an arc as the shape of the tool path during lift-down. As described above with reference to FIG. 2, the backward distance after lift-down is specified using the address M, and the shape of the tool path (arcuate trajectory) during lift-down is specified using the address P. The arcuate trajectory during lift-down is a trajectory that passes the position of the tool at the time of completion of lift-up and the position of the tool at the time of completion of lift-down, and whose tangent at the tool position at the time of completion of lift-down coincides with the line corresponding to the linear interpolation command.

Performing of the interrupt operation illustrated in FIG. 10 enables remaining chips to be cut off when remaining chips are left on the workpiece upon lift-up. In addition, the workpiece will be less likely to suffer from a tool mark when the tool is lifted down and comes into contact with the workpiece again.

FIG. 11 is a diagram illustrating a second example of interrupt operation performed by applying the numerical control device 1 according to the first embodiment.

The interrupt operation illustrated in FIG. 11 corresponds to a case in which the interrupting machining command does not include an argument specifying a backward distance (m) after lift-down or an argument specifying an arc as the shape of the tool path during lift-down, and machining is performed according to an arc interpolation command (G02 code). In the example illustrated in FIG. 11, the tool is lifted up each time the tool moves along an arc by the lift-up interval specified. The lift-up angle is the angle with respect to the tangent at the position at the start of lift-up of the tool.

Performing of the interrupt operation illustrated in FIG. 11 enables minimization of the increase in the cycle time, i.e., the time required for machining, caused by performing of the interrupt operation.

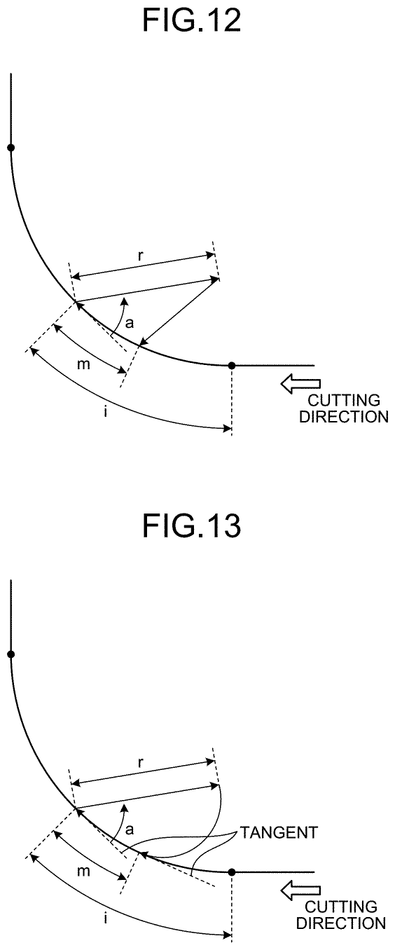

FIG. 12 is a diagram illustrating a third example of interrupt operation performed by applying the numerical control device 1 according to the first embodiment.

The interrupt operation illustrated in FIG. 12 corresponds to a case in which the interrupting machining command includes an argument specifying a backward distance (m) after lift-down, and machining is performed according to an arc interpolation command (G02 code). This differs from the interrupt operation illustrated in FIG. 11 in the position to which the tool returns by lift-down. In the example illustrated in FIG. 12, the tool is returned to a position that is the specified backward distance m back from the position at the start of lift-up.

Performing of the interrupt operation illustrated in FIG. 12 enables remaining chips to be cut off when remaining chips are left on the workpiece upon lift-up.

FIG. 13 is a diagram illustrating a fourth example of interrupt operation performed by applying the numerical control device 1 according to the first embodiment.

The interrupt operation illustrated in FIG. 13 corresponds to a case in which the interrupting machining command includes an argument specifying a backward distance (m) after lift-down and an argument specifying an arc as the shape of the tool path during lift-down, and machining is performed according to an arc interpolation command (G02 code). This differs from the interrupt operation illustrated in FIG. 12 in the shape of the tool path during lift-down. That is, in the example illustrated in FIG. 13, the shape of the tool path during lift-down forms an arcuate trajectory. The arcuate trajectory during lift-down is a trajectory that passes the position of the tool at the time of completion of lift-up and the position of the tool at the time of completion of lift-down, and whose tangent at the tool position at the time of completion of lift-down is the tangent to the arc corresponding to the arc interpolation command.

Similarly to the case of performing the interrupt operation illustrated in FIG. 10, performing of the interrupt operation illustrated in FIG. 13 enables remaining chips to be cut off when remaining chips are left on the workpiece upon lift-up. In addition, the workpiece will be less likely to suffer from a tool mark when the tool is lifted down and comes into contact with the workpiece again.

A hardware configuration of the control computing unit 40 included in the numerical control device 1 will now be described. FIG. 14 is a diagram illustrating an example hardware configuration of the control computing unit 40 included in the numerical control device 1 according to the first embodiment.

The control computing unit 40 can be implemented by a processor 101 and a memory 102 illustrated in FIG. 14. Examples of the processor 101 include a central processing unit (CPU) (also known as processing unit, computing unit, microprocessor, microcomputer, digital signal processor (DSP)), and a system large scale integration (LSI). Examples of the memory 102 include a random access memory (RAM) and a read-only memory (ROM).

The control computing unit 40 is implemented by the processor 101 by reading and executing a program for performing an operation of the control computing unit 40 stored in the memory 102. It can also be said that such program causes a computer to perform a procedure or method of the control computing unit 40. The memory 102 is also used as a temporary memory when the processor 101 performs various types of processing.

A program executed by the processor 101 may be a computer program product including a computer-readable non-transitory recording medium including multiple computer-executable instructions for performing data processing. The program executed by the processor 101 causes a computer to perform data processing using the multiple instructions.

Alternatively, the control computing unit 40 may be implemented in a dedicated hardware element. In addition, the functionality of the control computing unit 40 may be implemented partially in a dedicated hardware element and partially in software or firmware.

As described above, the numerical control device 1 according to the present embodiment reads an interrupting machining command newly defined, and controls the drive unit 10 provided in a machining device to perform an operation specified by different types of command values included in this command, specifically, an interrupt operation of temporarily stopping machining of the workpiece, separating the tool from the workpiece, thereafter bringing the tool into contact with the workpiece again, and restarting machining. This enables chips to leave from the workpiece when the tool is separated from the workpiece in an interrupt operation. In addition, because the operational conditions for the interrupt operation are specified using an interrupting machining command, a change in the rotational speed of the spindle does not affect the interrupt operation. That is, even after a change in the setting value of the rotational speed of the spindle, the numerical control device 1 can continue the interrupt operation under a same set of operational conditions, and can thus provide an operation of reliably breaking chips resulting from machining without being governed by the setting value of the rotational speed of the spindle.

### Second Embodiment

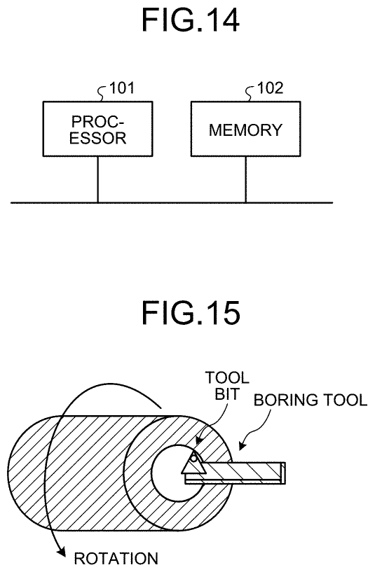

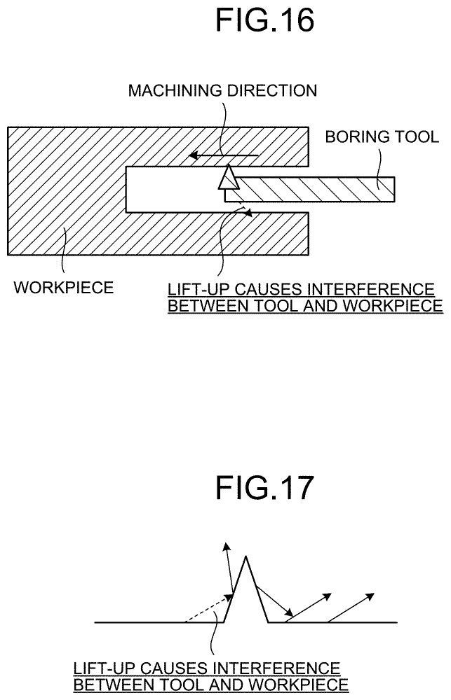

The first embodiment has been described in the context of an interrupt operation during machining of the periphery of a workpiece, but the workpiece may be bored or otherwise machined by turning machining as illustrated in FIG. 15. Such machining is known as boring machining. In this regard, when an interrupt operation is performed during boring machining to let chips leave from the workpiece, a problem such as the problem illustrated in FIG. 16 may occur. That is, performing of the interrupt operation described in the first embodiment during boring machining may cause an interference between the tool and the workpiece that is an object to be machined, as illustrated in FIG. 16 upon lifting up the boring tool, which is the tool. Interference may cause an adverse result such as a reduction in machining accuracy and/or a broken tool.

Thus, the present embodiment will be described in the context of a numerical control device capable of self correcting an operational condition for the interrupt operation to solve the problem upon occurrence of the foregoing problem. Note that it is not only boring machining that may cause a problem of interference between the tool and the workpiece. For example, machining such as that illustrated in FIG. 17 may also cause the foregoing problem of interference. In FIG. 17, each arrow represents the path of the tool during interrupt operation. In the example illustrated in FIG. 17, the relationships among the setting values of the lift-up interval, of the lift-up angle, and of the lift-up distance included in the operational conditions for the interrupt operation, will result in an interference when the tool is lifted up in the interrupt operation corresponding to the broken-line arrow.

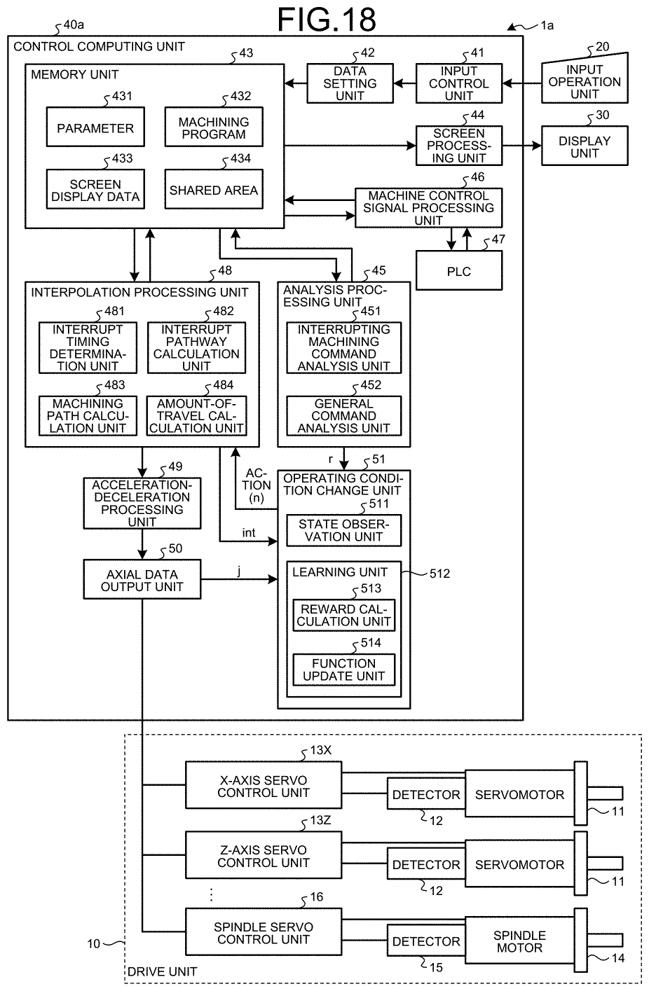

FIG. 18 is a diagram illustrating an example configuration of a numerical control device 1a according to a second embodiment. The numerical control device 1a is configured to further include an operating condition change unit 51 as compare to the numerical control device 1 according to the first embodiment.

The operating condition change unit 51 learns how to change an operational condition for the interrupt operation upon occurrence of an interference between the tool and the workpiece during interrupt operation. Specifically, the operating condition change unit 51 learns the situation in which an interference occurs between the tool and the workpiece during interrupt operation, and changes the applicable operational condition for the interrupt operation by using the result of learning. The operating condition change unit 51 is implemented, for example, by a machine learning device. An example of the operational conditions for the interrupt operation is the lift-up distance of the tool. The operating condition change unit 51 will be described below in the context of an example in which the lift-up distance of the tool is the applicable one of the operational conditions for the interrupt operation. The operating condition change unit 51 includes a state observation unit 511 and a learning unit 512.

The state observation unit 511 observes, as state variables, a current value (j) output by the axial data output unit 50, interruption-in-progress information (int) output by the interpolation processing unit 48, and a lift-up distance (r) output by the analysis processing unit 45. The current value (j) represents the value of current flowing through the servomotors 11 and through the spindle motor 14 of the drive unit 10. The interruption-in-progress information (int) represents whether an interrupt operation is in progress. The lift-up distance (r) represents the lift-up distance of the tool during interrupt operation. The current value (j) output by the axial data output unit 50 increases rapidly upon occurrence of an interference between the tool and the workpiece. Thus, the state observation unit 511 determines that an interference has occurred between the tool and the workpiece when the current value (j) increased rapidly while the interruption-in-progress information (int) indicates that an interrupt operation is in progress.

The learning unit 512 learns how to change the lift-up distance on the basis of a training dataset generated based on the state variables, which are the interruption-in-progress information (int), the lift-up distance (r), and the current value (j). That is, the learning unit 512 learns how much to change the lift-up distance for what result of observation about the interruption-in-progress information (int), about the lift-up distance (r), and about the current value (j) performed by the state observation unit 511.

The learning unit 512 may use any learning algorithm in the learning described above. A case of use of reinforcement learning will be described below by way of example. In reinforcement learning, an agent (actor) in a particular environment observes the present state, and determines what action to take. The agent receives a reward from the environment by selecting an action, and learns a policy that will achieve a highest reward through a sequence of actions. Major reinforcement learning techniques include Q-learning and TD-learning. For example, in a case of Q-learning, a typical update equation (action-value table) of an action-value function Q(s,a) is expressed by Formula (1).

$$\begin{matrix}[ Formula 1 ] & \\ Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) & ( 1 )\end{matrix}$$

In Formula (1), sₜ represents the environment at time t, and aₜ represents the action at time t. The action aₜ causes the environment to change to sₜ₊₁. In addition, rₜ₊₁ represents the reward received through the environmental change, γ represents the discount factor, and a represents the learning rate. In the case of application of Q-learning, the action aₜ corresponds to the change in the applicable operational condition (change in the lift-up distance) for the interrupt operation.

The update equation expressed by Formula (1) increases the action value Q when the action value Q of a best action “a” at time t+1 is higher than the action value Q of the action “a” taken at time t, and decreases the action value Q when the action value Q of a best action “a” at time t+1 is lower than the action value Q of the action “a” taken at time t. In other words, the action-value function Q(s,a) is updated to cause the action value Q of the action “a” at time t to approach the best action value at time t+1. This causes the best action value in a particular environment to sequentially propagate to the action values in the respective environments theretofore.

The learning unit 512 more specifically includes a reward calculation unit 513 and a function update unit 514.

The reward calculation unit 513 calculates the reward (k) based on the interruption-in-progress information (int), on the lift-up distance (r), and on the current value (j). For example, the reward (k) is reduced when the current value (j) has increased rapidly during the interrupt operation. The reward calculation unit 513 reduces the reward (k) by, for example, giving a reward of “−1”. Alternatively, if the current value (j) has not increased rapidly during the interrupt operation, the reward (k) is increased by giving a reward of “1”. Note that the lift-up-in-progress information, the lift-up distance (r), and the current value (j) used for learning are extracted using a known method. A reward of “−1” is interpreted as an indication of occurrence of an interference between the workpiece and the tool, thereby causing a lowest reward to be given.

The function update unit 514 updates the function for determining the change in the action (n), i.e., the change in the applicable operational condition (change in the lift-up distance (r)) for the interrupt operation, based on the reward calculated by the reward calculation unit 513. For example, in a case of Q-learning, the action-value function Q(sₜ,aₜ) expressed by Formula (1) is used as the function for determining the action (change in the lift-up distance (r)). For example, the learning unit 512 determines the amount of change in the lift-up distance (r) that will achieve a maximum reward. The lift-up distance (r) updated using the determined amount of change is transferred to the interrupt pathway calculation unit 482 of the interpolation processing unit 48 from the learning unit 512, as the action (n). The interrupt pathway calculation unit 482 calculates the travel path of the tool during the interrupt operation using the updated lift-up distance (r) provided from the learning unit 512.

According to the foregoing procedure, the operating condition change unit 51 of the numerical control device 1a determines the amount of change in the lift-up distance (r), and changes the lift-up distance (r) to achieve a maximum reward (k). The components other than the operating condition change unit 51 of the numerical control device 1a each perform processing similar to the processing of the component designated by the same reference character included in the numerical control device 1 according to the first embodiment. Description of the components other than the operating condition change unit 51 will therefore be omitted.

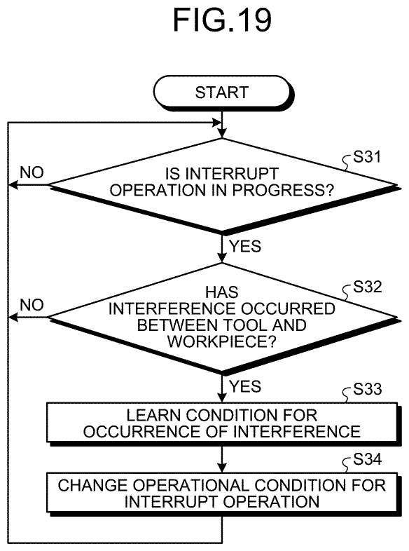

FIG. 19 is a flowchart illustrating an example of operation of the operating condition change unit 51 included in the numerical control device 1a according to the second embodiment.

As illustrated in FIG. 19, the operating condition change unit 51 monitors whether an interrupt operation is in progress (step S31), and if an interrupt operation is not in progress (step S31: No), continues monitoring. The operating condition change unit 51 determines whether an interrupt operation is in progress by checking the interruption-in-progress information (int). If an interrupt operation is in progress (step S31: Yes), the operating condition change unit 51 checks whether an interference has occurred between the tool and the workpiece (step S32). If the current value (j) has increased rapidly, the operating condition change unit 51 determines that an interference has occurred. If no interference has occurred (step S32: No), the operating condition change unit 51 returns the process back to step S31, and continues the process.

Alternatively, if an interference has occurred between the tool and the workpiece (step S32: Yes), the operating condition change unit 51 learns the condition for occurrence of an interference (step S33). The operating condition change unit 51 learns the condition for occurrence of an interference using, for example, the lift-up distance (r) and the current value (j).

The operating condition change unit 51 next changes the applicable operational condition for the interrupt operation based on the result of learning performed at step S33 (step S34). If the lift-up distance of the tool is the target to be changed at step S34, the operating condition change unit 51 changes, to a value lower than the present value, the lift-up distance of the tool to be used by the interrupt pathway calculation unit 482 of the interpolation processing unit 48 to calculate the path of the tool during the interrupt operation in the next cycle or later. The operating condition change unit 51 may determine the amount of change in the lift-up distance of the tool based on the current value (j). The operating condition change unit 51 calculates the amount of change such that, for example, a rapidly increased current value (j) that requires a longer time to decrease will result in a greater amount of change. After performing step S34, the operating condition change unit 51 returns the process back to step S31, and continues the process.

Note that the present embodiment has been described in which upon detection of occurrence of an interference between the tool and the workpiece during interrupt operation, the operating condition change unit 51 changes the lift-up distance of the tool to prevent an interference from occurring, but the operation is not limited thereto. The operating condition change unit 51 may change the lift-up angle of the tool upon detection of occurrence of an interference between the tool and the workpiece. Alternatively, the lift-up distance of the tool and the lift-up angle of the tool may both be changed. That is, the operating condition change unit 51 changes at least one of the lift-up distance of the tool and the lift-up angle of the tool upon occurrence of an interference between the tool and the workpiece.

In addition, the present embodiment has been described in which upon detection of an interference between the tool and the workpiece during interrupt operation, the operating condition change unit 51 uniformly changes the lift-up distance of the tool, that is, changes the lift-up distance of the tool for all iterations of the interrupt operation, but the operation is not limited thereto. The operating condition change unit 51 may be configured to also learn in which iteration(s) of the interrupt operation an interference occurs between the tool and the workpiece, of the iterations of the interrupt operation, and to change the lift-up distance of the tool only for the iteration(s) of the interrupt operation in which an interference occurs. In this case, the state observation unit 511 of the operating condition change unit 51 also observes, for example, the sequence number of the command currently being executed by the numerical control device 1a in addition to the interruption-in-progress information (int), the lift-up distance (r), and the current value (j) described above. The learning unit 512 learns how to change the lift-up distance using the interruption-in-progress information (int), the lift-up distance (r), the current value (j), and the sequence number of the command currently being executed.

Changing the lift-up distance of the tool for all iterations of the interrupt operation by the operating condition change unit 51 upon occurrence of an interference between the tool and the workpiece leads to a reduction of the cycle time, i.e., the time required for machining of one workpiece to be complete.

The control computing unit 40a included in the numerical control device 1a according to the second embodiment can be implemented in hardware similar to the hardware (see FIG. 14) for implementing the control computing unit 40 included in the numerical control device 1 according to the first embodiment.

As described above, the numerical control device 1a according to the present embodiment learns the condition for occurrence of an interference between the tool and the workpiece when an interrupt operation is performed, and changes the applicable operational condition for the interrupt operation by using the result of learning. This enables a state of interference between the tool and the workpiece to be automatically solved, and can thus reduce or eliminate the occurrence of a problem such as a reduction in machining accuracy and/or a broken tool.

Although the present embodiment has been described assuming that the operating condition change unit 51 is included in the numerical control device 1a, the operating condition change unit 51 may be configured to be disposed outside the numerical control device 1a. For example, the operating condition change unit 51 may be implemented such that an external machine learning device receives data for use in learning such as the interruption-in-progress information (int), the lift-up distance (r), and the current value (j) described above from the numerical control device 1 according to the first embodiment, and then learns how to change the operational conditions for the interrupt operation.

The configurations described in the foregoing embodiments are merely examples of various aspects of the present invention. These configurations may be combined with a known other technology, and moreover, a part of such configurations may be omitted and/or modified without departing from the spirit of the present invention.

### REFERENCE SIGNS LIST

1, 1a numerical control device; 10 drive unit; 11 servomotor; 12, 15 detector; 13X X-axis servo control unit; 13Z Z-axis servo control unit; 14 spindle motor; 16 spindle servo control unit; 20 input operation unit; 30 display unit; 40, 40a control computing unit; 41 input control unit; 42 data setting unit; 43 memory unit; 44 screen processing unit; 45 analysis processing unit; 46 machine control signal processing unit; 47 PLC; 48 interpolation processing unit; 49 acceleration-deceleration processing unit; 50 axial data output unit; 51 operating condition change unit; 431 parameter; 432 machining program; 433 screen display data; 434 shared area; 451 interrupting machining command analysis unit; 452 general command analysis unit; 481 interrupt timing determination unit; 482 interrupt pathway calculation unit; 483 machining path calculation unit; 484 amount-of-travel calculation unit; 511 state observation unit; 512 learning unit; 513 reward calculation unit; 514 function update unit.

1. A numerical control device for controlling a plurality of drive shafts that drive a tool for machining an object to be machined, the numerical control device comprising:
a first dedicated hardware element to perform processes of; or
a first processor and a first memory which, when executed by the first processor to, perform processes of:
analyzing a machining program;
calculating a machining path based on a result of analysis of the machining program performed by the analyzing, the machining path being a travel path of the tool in cutting machining of the object to be machined; and
calculating a travel path of the tool in an interrupt operation based on the result of analysis, the interrupt operation being an operation repeatedly performed in which the tool is temporarily lifted up from the machining path while the tool is moved along the machining path and is machining the object to be machined, wherein
the calculating of the travel path of the tool includes calculating a lift-up angle in a range from greater than 0° to less than or equal to 90°, the lift-up angle being an angle at which the tool is lifted up with respect to the machining path in the interrupt operation.

2. (canceled)

3. The numerical control device according to claim 1, wherein
the analyzing includes
analyzing an interrupting machining command including a command value specifying an operational condition for the interrupt operation, out of commands included in the machining program, and
in the calculating the travel path of the tool, the travel path of the tool in the interrupt operation is calculated based on the command value included in the interrupting machining command.

4. The numerical control device according to claim 3, wherein the interrupting machining command includes a command value specifying an amount of travel of the tool for lifting up of the tool from the machining path, and a command value specifying an angle between a direction of travel of the tool and the machining path upon lifting up of the tool from the machining path.

5. The numerical control device according to claim 4, wherein the interrupting machining command further includes a command value specifying a position to which the tool is to be returned to return the tool into contact with the object to be machined after lifting up of the tool from the machining path.

6. The numerical control device according to claim 4, wherein the interrupting machining command further includes a command value specifying whether a path of the tool should have a linear shape or an arcuate shape when the tool is returned into contact with the object to be machined after lifting up of the tool from the machining path.

7. The numerical control device according to claim 4, wherein the interrupting machining command further includes a command value specifying a length of time of maintaining the tool in an unmoved state after lifting up of the tool from the machining path.

8. The numerical control device according to claim 3, comprising:
a second dedicated hardware element to perform processes of, or
a second processor and a second memory which, when executed by the second processor to, perform processes of:
learning how to change the operational condition upon occurrence of an interference between the tool and the object to be machined during the interrupt operation.

9. The numerical control device according to claim 8, wherein
the learning is
implemented by a machine learning device that performs the learning using a value of current flowing through a servomotor that moves the tool during the interrupt operation, and using a command value specifying an amount of travel of the tool for lifting up of the tool from the machining path, out of command values included in the interrupting machining command.

10. A machine learning device that learns how to change an operational condition for the interrupt operation performed by the numerical control device according to claim 3 upon occurrence of an interference between the tool and the object to be machined during the interrupt operation, wherein
the learning is performed using a value of current flowing through a servomotor that moves the tool during the interrupt operation, and using a command value specifying an amount of travel of the tool for lifting up of the tool from the machining path, out of command values included the interrupting machining command.
